(19) United States
(12) Patent Application Publication
(10) Pub. No.: US 2005/0281953 A1
(43) Pub. Date: Dec. 22, 2005

(54) Coating apparatus and method

(76) Inventor: Kevin R. Carroll, Long Beach, CA (US)

Correspondence Address: FULBRIGHT AND JAWORSKI LLP, 555 S. FLOWER STREET, 41ST FLOOR, LOS ANGELES, CA, 90071, US

(21) Appl. No.: 10/873,869

(22) Filed: Jun. 21, 2004

(51) Int. Cl. B05D 1/18; B05D 3/12

(52) U.S. Cl. 427/355; 427/430.1

(57) ABSTRACT

A coating apparatus comprising a plurality of coating stations and a plurality of fluid reservoirs. The coating stations have a product path defined therethrough, and each coating station includes a collection basin, a product wipe, and a fluid output port. Each collection basin has a drain and opposing upstream and downstream side walls, each side wall including an aperture aligned with the product path. The product wipes are disposed adjacent the aperture in the downstream side wall of the respective collection basin. The fluid output ports are disposed above each respective collection basin such that fluid emerging therefrom is directed across the product path. Each fluid reservoir is fluidicly coupled to at least one of the coating stations.

### BACKGROUND OF THE INVENTION

1. Field of the Invention

The field of the present invention is the application of protective coatings.

2. Background

In-line processes for manufacturing pipe generally employ a cleaning step prior to a subsequent coating step, in which the pipe is coated with an anti-corrosion material such as a rust preventative. In the case of steel tubing, the primary goal of the cleaning process is to remove unwanted particulate matter, such as ferric oxide, from the external surface of the pipe. The cleaning step may include both mechanical processes to remove the particulate matter, such as is described in U.S. Pat. No. 5,647,906, issued to Monday et al., and chemical processes, such as is described in U.S. Pat. No. 4,073,978, issued to Womack et al., the disclosures of which are incorporated herein by reference.

Once the pipe is appropriately cleaned, the coating process applies the anti-corrosive coating. An example of coating a pipe by positioning a plurality of spray nozzles around the pipe is found in U.S. Pat. No. 5,316,588, issued to Dyla. An example of coating a pipe by bathing the pipe in the coating fluid is found in U.S. Pat. No. 4,304,822, issued to Heyl. The disclosures of each of the aforementioned patents is incorporated herein by reference.

In addition to the above steps, it may be necessary to include a rinsing step between the chemical cleaning process and the coating process to prevent undesirable interaction between the cleaning compounds and the coating compounds.

### SUMMARY OF THE INVENTION

The present invention is directed toward a coating apparatus and a method of coating. Both the apparatus and the method employ a plurality of coating stations, each coating station including at least a collection basin and a fluid output port disposed in proximity to the collection basin, and a plurality of fluid reservoirs, each of which is fluidicly coupled to at least one of the coating stations.

In a first separate aspect of the present invention, a product path is defined through the plurality of coating stations. Each collection basin includes a drain and opposing upstream and downstream side walls. The side walls each include an aperture which is aligned with the product path. A product wipe is disposed within each coating station adjacent the aperture in the downstream side wall of the respective collection basin.

In a second separate aspect of the present invention, a product wipe is disposed within each respective coating station, and at least one tether is wrapped about the product wipe. The tether is also tensionably coupled to the collection basin. The tension on the tether may be made adjustable, and the tether in one coating station may be tensioned differently than the tether in another coating station. Alternatively, each coating station may include more than one tether.

In a third separate aspect of the present invention, the coating stations are successively adjacent to one another. Under this configuration, immediately adjacent collection basins have integral upstream and downstream side walls, respectively.

In a fourth separate aspect of the present invention, the coating apparatus includes a plurality of pumps, each pump having an inlet disposed within one of the fluid reservoirs and an outlet fluidicly coupled to the fluid outlet port of one of the coating stations.

In a fifth separate aspect of the present invention, a method of practicing the invention includes directing a product through a plurality of coating stations, each coating station having a collection basin and a fluid output port disposed above the collection basin, pumping fluid into the coating stations through the respective fluid output ports, wiping excess fluid from the product within each coating station, and collecting excess fluid in the respective collection basins. Fluid pumped into the most downstream coating station, relative to the product path, is supplied by a clean, uncontaminated fluid source. Fluid pumped into all other coating stations is supplied by the collected excess fluid.

In a sixth separate aspect of the present invention, any of the foregoing aspects may be employed in combination.

Accordingly, the present invention provides an improved coating apparatus and method of coating a product. Other objects and advantages will appear hereinafter.

### BRIEF DESCRIPTION OF THE DRAWINGS

In the drawings, wherein like reference numerals refer to similar components:

FIG. 1 illustrates a pipe coating apparatus;

FIG. 2 illustrates the collection basins of the apparatus of FIG. 1;

FIG. 3 is a top elevational view of the coating stations of FIG. 1; and

FIG. 4 is partial sectional view along the line 4-4 of FIG. 3.

### DETAILED DESCRIPTION OF THE PREFERRED EMBODIMENTS

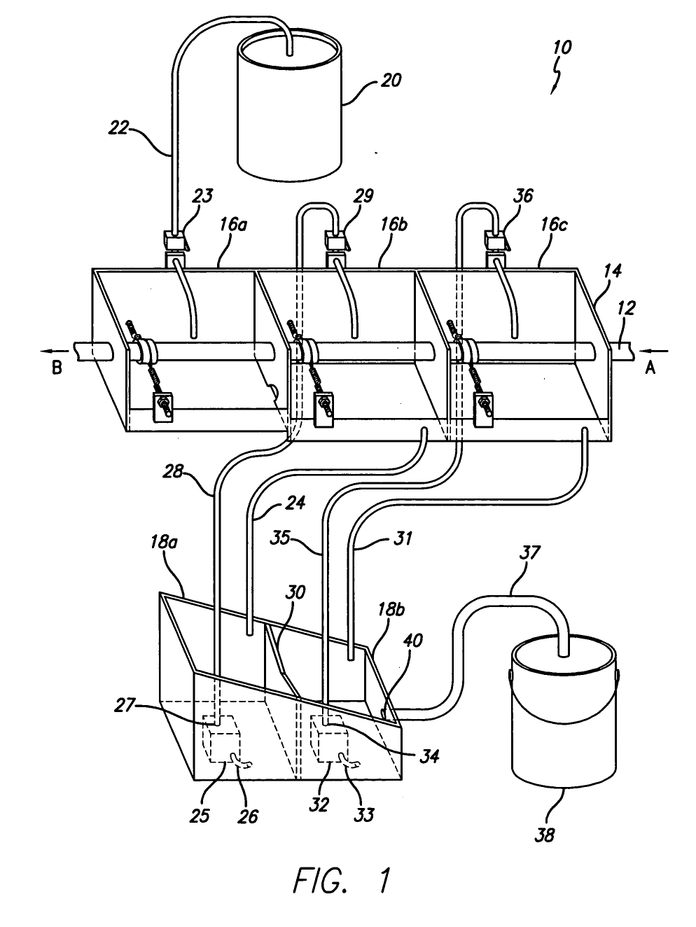

Turning in detail to the drawings, FIG. 1 illustrates a pipe coating apparatus 10 in accordance with a preferred embodiment of the present invention. This coating apparatus is configured to both clean unwanted contaminants (e.g., ferric oxide and dirt or dust from the manufacturing process, among others) from and deposit a protective coating on steel pipes. The cleaning and coating process is achieved using one type of fluid in a single cascade-style washing apparatus, thereby simplifying the overall manufacturing process. Preferably, non-volatile fluid (a requirement under current government standards) is used which is a rust preventative for steel pipes. Those skilled in the relevant arts will recognize that the coating apparatus and process described herein is adaptable to accommodate other types of products, including products with non-round cross-sectional shapes, and/or coatings.

A pipe 12 passes through a plurality of immediately adjacent coating stations 14 along the product path, which is defined by the arrows labeled “A” and “B”. The arrow “A” indicates the point at which the pipe enters the coating stations and represents the upstream side of the product path. The arrow “B” indicates the point at which the pipe emerges from the coating stations and represents the downstream side of the product path. Three coating stations 16a, 16b, 16c are shown as forming part of the coating apparatus, although more or fewer could be employed. The coating apparatus also includes two fluid reservoirs 18a, 18b, each of which is fluidicly coupled to at least one of the coating stations 16a, 16b, 16c.

Tracing the flow path of fluid through the coating apparatus 10, fresh or uncontaminated fluid is initially stored and drawn from the fluid source, which is depicted as a large drum 20. The drum 20 is connected to the first or most downstream coating station 16a with tubing 22 (or piping) that is appropriate for transporting the type of fluid being used. A pump (not shown) is used to draw fluid from the drum 20 into the tubing 22. A flow control valve 23 controls the flow of fluid from the tubing 22 into the first coating station 16a. Fluid in the first coating station 16a flows into the second or immediately upstream coating station 16b in the manner described further below.

Fluid flows out of the second coating station 16b through the tubing 24 and into the first fluid reservoir 18a by positioning the tubing 24 directly above the first fluid reservoir 18a and allowing fluid to freely flow from the tubing 24. A submersible pump 25 is disposed within the first fluid reservoir 18a. The pump has an inlet 26 disposed within the first fluid reservoir 18a, and an outlet 27 affixed to the tubing 28. The pump 25 draws fluid from the first fluid reservoir 18a into the tubing 28, which transports fluid up to the second coating station 16b. A flow control valve 29 controls the flow of fluid from the tubing 28 into the coating station 16b.

The two fluid reservoirs 18a, 18b are divided by a wall 30, the top of which is V-shaped. This V-shaped wall 30 allows overflow from the first fluid reservoir 18a to drain into the second fluid reservoir 18b, and helps prevent spillage outside of the two fluid reservoirs 18a, 18b. The second fluid reservoir 18b also receives fluid from the third coating station 16c through the tubing 31. A submersible pump 32 is disposed within the second fluid reservoir 18b. The pump 32 has an inlet disposed within the second fluid reservoir 18b and an outlet affixed to the tubing 35. The pump 32 draws fluid from the second fluid reservoir 18b into the tubing 35, which transports fluid up to the third coating station 16c. The flow control valve 36 controls the flow of fluid into the third coating station 16c.

A drain 40 is disposed within a wall of the second fluid reservoir 18b to act as an overflow control for the second fluid reservoir 18b. The drain 40 is positioned above the floor of the second fluid reservoir 18b to allow fluid to pool within the second fluid reservoir 18b. Fluid passes through the drain 40, into the piping 37, and into a waste receptacle 38. To reduce the need of mechanical parts such as pumps and level sensors, the waste receptacle 38 may be placed at a lower potential gravity as compared to the drain 40. In this manner, fluid will flow out of the second fluid reservoir 18b and directly into the waste receptacle 38.

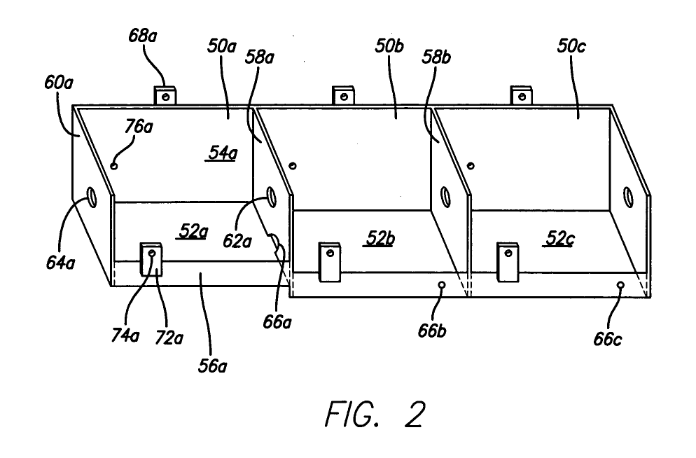

FIG. 2 illustrates the collection basins 50a, 50b, 50c which form part of the coating stations illustrated in FIG. 1. Except where otherwise noted, the collection basins 50a, 50b, 50c are all similarly configured. The first collection basin 50a includes a bottom 52a, a high rear wall 54a, a low front wall 56a, and two side walls 58a, 60a. The bottom 52a of the first collection basin 50a is kept at a higher potential gravity than the bottom 52b of the second collection basin 50b. This allows and encourages fluid to flow from the first collection basin 50a into the second collection basin 50b through the drain 66a disposed in the side wall 58a separating the two collection basins 50a, 50b. Similarly, drains 66b, 66c are included in the front side walls 56b, 56c, respectively. Referring to both FIGS. 1 and 2, the fluid reservoirs 18a, 18b are maintained at a lower potential gravity as compared to the coating stations 16b, 16c, respectively, to allow and encourage fluid to flow out of the collection basins 50b, 50c and into the fluid reservoirs 18a, 18b via the tubes 24, 31 which are coupled to the drains 66b, 66c, respectively.

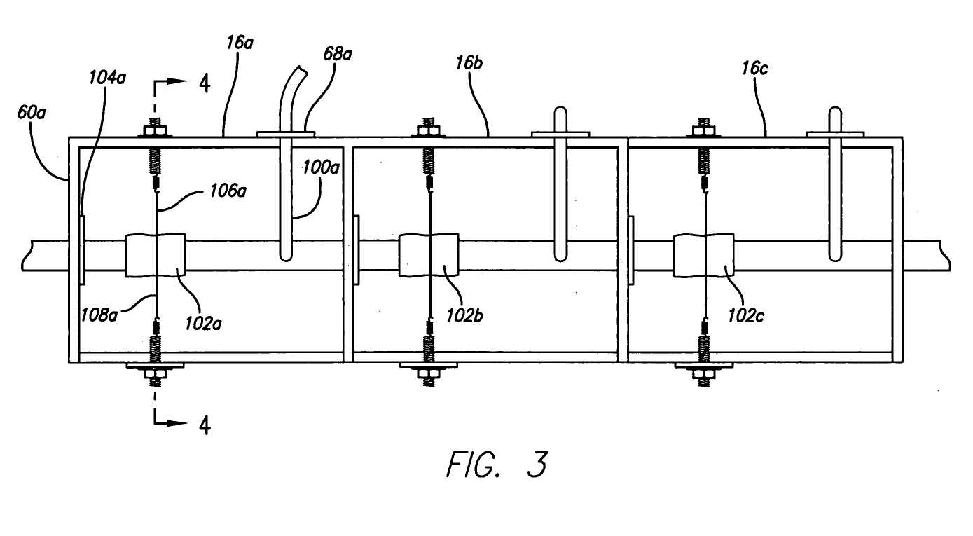

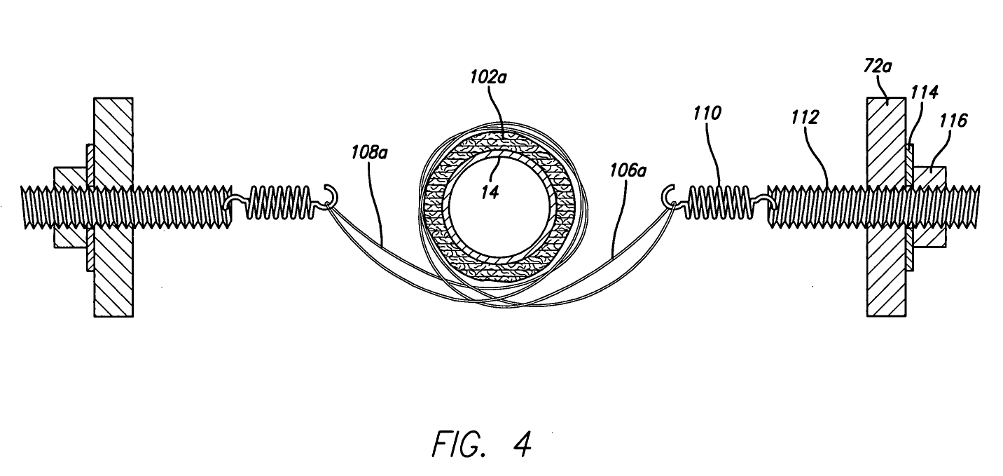

A flange 68a extends upward from the rear wall 54a to provide support for the fluid output port (as shown in FIG. 1). The low front wall 56a associated with each collection basin permits easy access to the internal portion of each collection basin. A flange 72a extends upward from the low front wall 56a to provide support for one of the two tethers as described below in connection with FIGS. 3 and 4. The other of the two tethers is supported by attachment at the hole 76a in the back wall 54a.

The side wall 60a is the downstream side wall of the first collection basin 50a. Similarly, the side wall 58a is the upstream side wall of the first collection basin 50a. Likewise, the side wall 58a is the downstream side wall of the second collection basin 50b, and the side wall 58b is the upstream side wall thereof. Thus, the side wall 58a serves as both an upstream side wall for collection basin 50a and as a downstream side wall for collection basin 50b. The side wall 58a includes aperture 62a, and the side wall 60a includes aperture 62b. The combination of apertures in the side walls of the collection basins 50a, 50b, 50c are aligned with and help define the product path through the coating stations.

Turning to FIG. 3, wherein each coating station is similarly configured unless otherwise noted, the first coating station 16a includes a fluid output port 100a which is supported by the flange 68a. The fluid output port 100a is constructed of semi-flexible tubing which may be positioned appropriately as needed, although other materials may be used. The fluid output port 100a extends outward from the flange 68a so that its opening is positioned above the product path. Fluid emerging from the fluid output port 100a is thus directed across the product path. When product is present, fluid will flow onto and around the product

A product wipe 102a is disposed within the first coating station 16a and is wrapped around and forms a sleeve about the product as the product passes through the first coating station 16a. The product wipe 102a is positioned downstream of the fluid output port 100a and is adjacent the side wall 60a. The product wipe 102a wipes excess fluid and debris from the product as the product passes through the first coating station 16a.

A retainer 104a is affixed to the downstream wall 60a and includes an aperture through which the product may pass. The retainer 104a helps maintain the product in the product path when the aperture 64a is substantially larger than the product. This permits a single coating apparatus to accommodate products of varying sizes by placing an appropriately sized retainer in each coating station.

The amount of fluid and debris which the product wipe 102a removes from the product is controlled by the tensionable tethers 106a, 108a of each coating station. Referring to FIG. 4, each tether 106a, 108a is wrapped around the product wipe 102, which is in turn wrapped about the pipe 14. (The tethers in FIG. 4 are shown very loosely wrapped around the product wipe to emphasize the manner in which they are wrapped. In practice, the tethers would be at least in contact with the product wipe and exerting a desired amount of pressure on the product wipe.) The tethers 106a, 108a are wrapped once around the product wipe 102a, with one tether being wound in a left-handed manner and the other being wound in a right-handed manner. Alternative configurations, such as having each tether wrapped only partially about the product wipe, each tether wrapped more than once around the product wipe, or having the two tethers wrapped in different manners about or around the product wipe, may also be employed.

The two tethers 106a, 108a are tensionably coupled to the walls of the collection basin on opposite sides of the product path. The tether 106a, after being wrapped around the product wipe 102, is affixed to the spring 110, which is in turn affixed to the threaded rod 112. The threaded rod 112 extends through the flange 72a and is secured by a washer 114 and threaded nut 116. Under this configuration, the threaded nut 116 and the threaded rod 112 may be used to increase or decrease tension in the spring 110, and thus increase or decrease tension in the tether 106a. The tether 108a is affixed to the rear wall of the collection basin in a similar manner.

The tensionable tethers 106a, 108a wrapped around the product wipe 102a exert a constricting pressure about the entire circumference of the product wipe 102a. This constricting pressure is increased or decreased by adjusting the tension in the tethers 106a, 108a. Further, by adjusting the constricting pressure on the product wipe 102a, the amount of debris and fluid removed from the product in each coating station may be set at a desired level for maximum efficiency of the coating apparatus as a whole. For example, within the third coating station 16c, the pipe entering the coating apparatus may have a large quantity of unwanted debris, e.g., ferric oxide, dirt, and dust particles, among other things. Therefore, at this stage of the coating apparatus, a low amount of tension might be placed on the tethers so that much of the debris can be removed by the product wipe without abrading the surface of the pipe. Then, in the second coating station 16b, more of the debris might be removed by application of greater tension in the tethers. Finally, in the first coating station 16a, at which point most if not all of the unwanted debris has been removed from the product by the previous two coating stations, the constricting pressure placed on the product wipe might be such that only a thin layer of fluid is left to dry on the pipe after the pipe emerges from the coating apparatus. This apparatus and process may include as many coating stations as is appropriate for efficiently cleaning and coating the product.

Using the above apparatus and process, clean and uncontaminated fluid will be placed on the product in the most downstream coating station 16a. The excess fluid from this step of the process may no longer be appropriate for use in the most downstream coating station 16a because it is somewhat contaminated after being. exposed to the product and the first coating station 16a. Fluid from the first coating station 16a, while it maybe unsuitable for reuse in that coating station, should be acceptable for use in the second or immediately upstream coating station 16b. Fluid is therefore passed from the first coating station 16a into the second coating station 16b where it is used until it overflows from the first fluid reservoir 18a into the second fluid reservoir 18b. At that time, fluid is circulated between the third coating stations 16c and the second fluid reservoir 18b, until the second fluid reservoir 18b overflows into the waste receptacle 38. Control of fluid flowing from the fluid source into the first coating station 16a, between the second coating station 16b and the first fluid reservoir 18a, and between the third coating station 16c and the second fluid reservoir 18b may ensure that none of the coating stations are reusing fluid that is too contaminated for any particular step of the process and that the product is being appropriately cleaned and coated. The amount of control will depend upon, among other things, the type of product being coated, the type of coating fluid, and the number of coating stations included in the process.

Thus, an improved apparatus for and method of coating a product are disclosed. While embodiments of this invention have been shown and described, it will be apparent to those skilled in the art that many more modifications are possible without departing from the inventive concepts herein. The invention, therefore, is not to be restricted except in the spirit of the following claims.

1. A coating apparatus comprising:
a plurality of coating stations having a product path defined therethrough, each coating station including
a collection basin having a drain and opposing upstream and downstream side walls, wherein each of opposing upstream and downstream side walls includes an aperture aligned with the product path,
a product wipe disposed within the coating station adjacent the aperture in the downstream side wall of the collection basin, and
a fluid output port disposed above the collection basin; and
a plurality of fluid reservoirs, each fluid reservoir being fluidicly coupled to at least one of the coating stations.

2. The apparatus of claim 1 further comprising a plurality of pumps, each pump having an inlet disposed within one of the fluid reservoirs and an outlet fluidicly coupled to the fluid output port of one of the coating stations.

3. The apparatus of claim 1, wherein the fluid output port of each coating station is disposed above the collection basin such that fluid is directed across the product path.

4. The apparatus of claim 1, each coating station further including a retainer disposed between the product wipe and the downstream side wall.

5. The apparatus of claim 1, each coating station further including at least one tether wrapped about the product wipe and tensionably coupled to the collection basin.

6. The apparatus of claim 5, wherein the at least one tether is tensionably coupled to the collection basin with a spring.

7. The apparatus of claim 5, wherein tension in the at least one tether is adjustable.

8. The apparatus of claim 1, wherein the fluid output port of a most downstream coating station is fluidicly coupled to a fluid source.

9. The apparatus of claim 1, wherein each fluid reservoir is fluidicly coupled to one of the coating stations, respectively, via the drain in the collection basin.

10. The apparatus of claim 1, wherein a first of the fluid reservoirs is fluidicly coupled with a second of the fluid reservoirs such that overflow from the first of the fluid reservoirs is directed into the second of the fluid reservoirs.

11. The apparatus of claim 1, wherein one of the fluid reservoirs is fluidicly coupled with a waste receptacle such that overflow from the one of the fluid reservoirs is directed into the waste receptacle.

12. The apparatus of claim 1, wherein the coating stations are successively adjacent one another and immediately adjacent coating stations have integral upstream and downstream side walls, respectively.

13. A coating apparatus comprising:
a plurality of coating stations having a product path defined therethrough, each coating station including
a collection basin having a drain and opposing upstream and downstream side walls, wherein each of opposing upstream and downstream side walls includes an aperture aligned with the product path,
a product wipe disposed within the coating station adjacent the aperture in the downstream side wall of the collection basin,
at least one tether wrapped about the product wipe and tensionably coupled to the collection basin, and
a fluid output port disposed above the collection basin;
a plurality of fluid reservoirs, each fluid reservoir being fluidicly coupled to at least one of the coating stations; and
a plurality of pumps, each pump having an inlet disposed within one of the fluid reservoirs and an outlet fluidicly coupled to the fluid output port of one of the coating stations.

14. The apparatus of claim 13, wherein the fluid output port of each coating station is disposed above the collection basin such that fluid is directed across the product path.

15. The apparatus of claim 13, each coating station further including a retainer disposed between the product wipe and the downstream side wall.

16. The apparatus of claim 13, wherein the at least one tether is tensionably coupled to the collection basin with a spring.

17. The apparatus of claim 13, wherein tension in the at least one tether is adjustable.

18. The apparatus of claim 13, wherein the fluid output port of a most downstream coating station is fluidicly coupled to a fluid source.

19. The apparatus of claim 13, wherein each fluid reservoir is fluidicly coupled to one of the coating stations, respectively, via the drain in the collection basin.

20. The apparatus of claim 13, wherein a first of the fluid reservoirs is fluidicly coupled with a second of the fluid reservoirs such that overflow from the first of the fluid reservoirs is directed into the second of the fluid reservoirs.

21. The apparatus of claim 13, wherein one of the fluid reservoirs is fluidicly coupled with a waste receptacle such that overflow from the one of the fluid reservoirs is directed into the waste receptacle.

22. The apparatus of claim 13, wherein the coating stations are successively adjacent one another and immediately adjacent coating stations have integral upstream and downstream side walls, respectively.

23. A coating apparatus comprising:
a plurality of successively adjacent coating stations having a product path defined therethrough, each coating station including
a collection basin having a drain and opposing upstream and downstream side walls, wherein each of opposing upstream and downstream side walls includes an aperture aligned with the product path and immediately adjacent collection basins have integral upstream and downstream side walls, respectively,
a product wipe disposed within the coating station adjacent the aperture in the downstream side wall of the collection basin,
at least two tethers wrapped around the product wipe and tensionably coupled to the collection basin, and
a fluid output port disposed above the collection basin such that fluid is directed across the product path;
a plurality of fluid reservoirs, each fluid reservoir being fluidicly coupled to at least one of the coating stations; and
a plurality of pumps, each pump having an inlet disposed within one of the fluid reservoirs and an outlet fluidicly coupled to the fluid output port of one of the coating stations.

24. The apparatus of claim 23, each coating station further including a retainer disposed between the product wipe and the downstream side wall.

25. The apparatus of claim 23, wherein each of the tethers is tensionably coupled to the collection basin with a spring.

26. The apparatus of claim 23, wherein tension in each of the tethers is adjustable.

27. The apparatus of claim 23, wherein the fluid output port of a most downstream coating station is fluidicly coupled to a fluid source.

28. The apparatus of claim 23, wherein each fluid reservoir is fluidicly coupled to one of the coating stations, respectively, via the drain in the collection basin.

29. The apparatus of claim 23, wherein a first of the fluid reservoirs is fluidicly coupled with a second of the fluid reservoirs such that overflow from the first of the fluid reservoirs is directed into the second of the fluid reservoirs.

30. The apparatus of claim 23, wherein one of the fluid reservoirs is fluidicly coupled with a waste receptacle such that overflow from the one of the fluid reservoirs is directed into the waste receptacle.

31. A method of coating a product comprising:
directing a product through a plurality of coating stations, each coating station including a collection basin and a fluid output port disposed above the collection basin;
pumping fluid into the coating stations through each respective fluid output port, the fluid flowing onto and around the product;
wiping excess fluid from the product within each coating station; and
collecting excess fluid in each respective collection basin, wherein fluid pumped into a most downstream coating station is supplied by a fluid source and fluid pumped into all other coating stations is supplied by the collected excess fluid.

32. The method of claim 31, wherein directing a product through a plurality of coating stations includes directing a product through a plurality of immediately adjacent coating stations.

33. The method of claim 31, wherein wiping excess fluid from the product includes placing a product wipe around the product.

34. The method of claim 33, wherein wiping excess fluid from the product includes placing at least one tether about each product wipe and tensionably coupling the at least one tether to a wall of each respective collection basin.

35. The method of claim 34, wherein tensionably coupling the at least one tether includes tensionably coupling the at least one tether to the wall of each respective collection basin with a spring.

36. The method of claim 34, wherein the tether of a first of the coating stations is tensioned differently as compared to the tether of a second of the coating stations.

37. The method of claim 31 further comprising draining the collected excess fluid from each collection basin into a plurality of fluid reservoirs.

38. The method of claim 37, wherein the collected excess fluid from at least two of the collection basins drains into different fluid reservoirs.

39. The method of claim 37, further including directing overflow from a first of the fluid reservoirs into a second of the fluid reservoirs.

40. The method of claim 37, further including directing overflow from a first of the fluid reservoirs into a waste receptacle.

41. The method of claim 31, wherein the fluid is a non-volatile fluid.

42. The method of claim 41, wherein the non-volatile fluid is a rust preventative.

43. A method of coating a product comprising:
directing a product through a plurality of immediately adjacent coating stations, each coating station including a collection basin and a fluid output port disposed above the collection basin;
pumping fluid into the coating stations through each respective fluid output port, the fluid flowing onto and around the product;
wiping excess fluid from the product within each coating station with a product wipe, the product wipe being placed around the product, wherein at least two tethers are placed around the product wipe and tensionably coupled to walls of each respective collection basin;
collecting excess fluid in each respective collection basin; and
draining the collected excess fluid from each collection basin into a plurality of fluid reservoirs, wherein fluid pumped into a most downstream coating station is supplied by a fluid source and fluid pumped into all other coating stations is supplied by fluid from the fluid reservoirs.

44. The method of claim 43, wherein tensionably coupling the at least two tethers includes tensionably coupling the at least two tethers to walls of each respective collection basin with a spring.

45. The method of claim 43, wherein the tethers of a first of the coating stations are tensioned differently as compared to the tethers of a second of the coating stations.

46. The method of claim 43, wherein the collected excess fluid from at least two of the collection basins drains into different fluid reservoirs.

47. The method of claim 43, further including directing overflow from a first of the fluid reservoirs into a second of the fluid reservoirs.

48. The method of claim 43, further including directing overflow from a first of the fluid reservoirs into a waste receptacle.

49. The method of claim 43, wherein the fluid is a non-volatile fluid.

50. The method of claim 43, wherein the non-volatile fluid is a rust preventative.
